(19) United States
(12) Patent Application Publication
(10) Pub. No.: US 2026/0175288 A1
(43) Pub. Date: Jun. 25, 2026

(54) CASTING MOLD

(71) Applicant: Schock GmbH, Regen (DE)

(72) Inventors: Alois PROBST, Regen (DE); Markus MÜLLER, Regen (DE)

(21) Appl. No.: 19/424,927

(22) Filed: Dec. 18, 2025

(30) Foreign Application Priority Data
Dec. 20, 2024 (DE) 10 2024 139 212.6

(51) Int. Cl. B22C 9/06; B22C 9/10

(52) U.S. Cl. CPC B22C 9/064; B22C 9/062; B22C 9/065; B22C 9/108

(57) ABSTRACT

A casting mold for producing a casting having a front and a rear side from a curable casting compound, having at least one first mold part with a front mold face that shapes the front side and a second mold part with a rear mold face that shapes the rear side, which mold parts conjointly delimit a casting cavity. Provided on the rear mold face is a first fastening interface and provided on an insert part, by way of which a through hole on the casting is to be formed, is a second fastening interface. The insert part in the case of a closed mold bears on the rear mold face as well as on the front mold face. The two fastening interfaces are releasably connectable to one another in such a manner that, when removing the second mold part from the cured casting, the first fastening interface is automatically released from the second fastening interface.

### CROSS-REFERENCE TO RELATED APPLICATIONS

The present application claims priority of DE 102024139 212.6, filed December 20, 2024, the priority of this application is hereby claimed, and this application is incorporated herein by reference.

### BACKGROUND OF THE INVENTION

The invention relates to a casting mold for producing a casting having a front and a rear side from a curable casting compound, having at least one first mold part with a front mold face that shapes the front side and a second mold part with a rear mold face that shapes the rear side, which mold parts conjointly delimit a casting cavity.

A three-dimensionally shaped casting can be produced from a curable casting compound made of a composite material using a suitable casting mold, in that the casting compound is incorporated into a casting cavity when the casting mold is closed, cures in the latter, and the casting is retrieved once the mold has been opened. A polymeric acrylic-based casting compound with organic and/or inorganic particles distributed therein is usually used as casting compound. A non-limiting example of such a casting is a kitchen sink which, depending on the shape and design, has one or a plurality of basin regions and optionally one or a plurality of lateral storage surfaces. Another example is a shower tray which has a flat bottom portion and an encircling peripheral portion which in terms of its height is sized according to the depth of the shower tray.

Sometimes it is necessary to form an opening on the casting, which allows water to drain. In the case of a kitchen sink or a sink, for example, in Europe, an overflow opening must be provided in accordance with regulations so that the water flowing into the sink cannot spill over the periphery of the sink. When the overflow opening is reached, water flows successively via the overflow opening into the drain. Thus, even if the tap is not turned off, spillage and thus flooding is avoided in this way. Incorporating such an opening, in particular such an overflow opening, into a sink component has conventionally been performed mechanically in that the overflow opening is incorporated into the completed, cured casting by drilling or milling into an almost vertical basin wall, which is very complex. It is impossible to form the overflow opening immediately during casting in the mold, as this would lead to an undercut on the mold or mold faces such that the casting can no longer be removed. Sliders, as in injection molds, cannot be used in such a case, since the methyl methacrylate component of the polymeric casting compound is very runny and thus runs into the smallest gap and clogs it.

### SUMMARY OF THE INVENTION

The invention is based on the object of specifying a casting mold which simplifies forming an opening in the casting, in particular an overflow opening in a sink component.

In order to achieve the object, it is provided according to the invention in a casting mold of the type mentioned at the outset that to be provided on the rear mold face is a first fastening interface and to be provided on an insert part, by way of which a through hole on the casting is to be formed, is a second fastening interface, wherein the insert part in the case of a closed mold bears on the rear mold face as well as on the front mold face, and wherein the two fastening interfaces are releasably connectable to one another in such a manner that, when removing the second mold part from the cured casting, the first fastening interface is automatically released from the second fastening interface.

The casting mold according to the invention allows an opening to be implemented in an extremely simple way after removal of the finished casting, while using an insert part. For this purpose, the rear mold face of the second mold part has a first fastening interface. A second fastening interface is provided on an insert part which defines the geometry of the opening to be formed, for example, the overflow opening in the sink component. Before closing the mold, the insert part is fixed by way of its second fastening interface to the first fastening interface, wherein, when the mold is closed, the insert part bears on the rear mold face as well as on the front mold face, thus connecting the two. When the casting compound is now incorporated into the casting cavity, the casting compound is distributed about the insert part, the latter thus being embedded in the casting compound. After the casting compound has cured, the mold is then opened and the second mold part is removed from the casting. This movement causes the second fastening interface of the insert part to be released from the first fastening interface on the rear mold face, the connection thus being separated. The insert part, which is firmly embedded in the casting, therefore remains in the casting. In order to open the opening in the casting, the insert part then only has to be pushed out of the casting, for example to be knocked out with a suitable tool, wherein the removal of the insert part automatically forms the opening, for example, the overflow opening in the sink body, is formed. The invention thus permits the formation of a defined opening region within the cured casting by embedding the insert part in the casting mold, wherein after demolding the insert part remains in the mold body and is only then to be removed from the latter, for example by knocking it out, while simultaneously forming an accurately shaped opening. Since the geometry or peripheral shape of the opening is defined by way of the insert part, the geometry can easily be varied almost arbitrarily, depending on the shaping of the insert part. The opening can be circular, it can be oval, triangular or polygonal, elongate, etc. This means that, in addition to a simple design of the opening, there is also a wide range of variations available with regard to the opening geometry.

According to a refinement of the invention, it can be provided that the second fastening interface can is insertable into the first fastening interface by way of a linear sliding movement and, when removing the second mold part, the second fastening interface is extractable from the first fastening interface by way of a linear movement. The insert part is thus fixed to the second mold part by way of a simple sliding movement, which allows the insert part to be very easily disposed on the second mold part or the rear mold face, respectively. This simple linear connection also has the effect that the connection can be released again in a correspondingly simple way after the casting has been produced, i.e. that when the second mold part is removed, the two fastening interfaces are can in turn be mutually separated again by way of a simple linear movement.

A formulaic design embodiment of the invention provides that the first fastening interface and the second fastening interface establish a clamping connection. Such a clamping connection is already sufficient to ensure secure fixing of the insert part to the second mold part or the rear mold face. Due to the simple clamping, on the one hand, the disposal of the insert part is simple, particularly in conjunction with the simple linear fastening movement, while, on the other hand, sufficient fixing is provided by the clamping action when the mold is closed, wherein then the insert part is firmly held between the rear mold face and the front mold face, while bearing on both mold faces. This fixing action is also quite sufficient to keep the insert part in position during the casting process, i.e. when the liquid casting compound is incorporated into the casting cavity.

A particularly advantageous embodiment of such a clamping connection can be implemented according to a refinement of the invention, in that the first fastening interface and the second fastening interface establish a dovetail connection. A dovetail connection is a form-fitting connection that has a form-fit in the transverse direction as well as in the longitudinal direction. The one fastening portion is formed as a quasi trapezoidal protrusion, while the other fastening portion is formed as a corresponding shape-compatible, trapezoidal recess or groove into which the protrusion is inserted and in which the latter is received in a form-fitting manner. Presently, the one fastening interface is formed as an elongate groove and the other fastening interface as an elongate protrusion, wherein the elongate protrusion is inserted into the negative of the groove in the course of the linear joining movement while engaging in a form-fitting manner in the dovetail geometry. Particularly preferably, the width of the protrusion and the width of the groove slightly decrease from one end to the other end, i.e. providing a slight wedge shape, by way of which a clamping effect can be achieved in a particularly simple way when both portions are inserted into one another. However, such a variable geometry is not mandatory, rather, the respective width can also remain constant, wherein a minimum oversize can be provided on the protrusion in order to achieve the clamping effect.

In order to allow the easy disconnection of the two fastening interfaces in the context of such a clamping fastening, which always necessitates a certain form-fit, it is expedient when the first fastening interface is disposed on a wall portion of the rear mold face that is at an angle of 0.1° - 7° relative to a linear axis of movement of the second mold part. Such a small angle also allows corresponding disconnecting even in a form-fit over a correspondingly large area, as is provided in a dovetail connection, for example, when the second mold part and the casting are moved relative to one another, so that a relatively short linear movement is already sufficient for opening the connection at the fastening interface. However, the angle should not be excessive, in particular in a dovetail connection, and should be approx. 5-6°. If there is no corresponding tongue-and-groove engagement, as is the case with a dovetail connection, the corresponding angle may also be slightly larger.

As an alternative to the clamping connection, the first fastening interface and the second fastening interface can also establish a latching connection. The clamping connection is particularly advantageous if the opening is to be formed on a wall of the casting that runs almost vertically or is formed via a vertical casting cavity section in the mold, since very simple releasing is made possible when pulling apart the mold halves or when demolding the casting. A latching connection as an alternative is expedient for forming openings which are to be formed in the region of a base portion, for example, the latter being defined by an almost horizontally extending portion of the casting cavity. Since in this case, the axis of movement of the second mold part is almost perpendicular to the formed base portion, a corresponding latching connection which is positively separated when the second mold part is moved, or when the casting is demolded, can also be formed. Thus, for example, a base drain opening can be formed on a casting while using an insert part that establishes a latching connection. Of course, a corresponding clamping connection can also be used in this case instead of a latching connection.

A base drain opening (horizontal portion of the casting cavity by way of which a base of a kitchen sink basin is formed) may also be generated by attaching the insert part, with or without a latching connection or clamping connection, to a mandrel, or inserting it into a depression, such that the insert part extends almost perpendicularly to the direction of movement of the second mold half. Since the direction of movement of the second mold part extends almost perpendicularly to the substantially horizontal portion of the rear mold face, the insert part can be extracted from the mandrel or from the depression during demolding, and the casting can be readily demolded.

If a latching connection is implemented between the insert part and the second mold half, according to the invention, the first fastening interface can be disposed on a wall portion of the rear mold face that is at an angle of 85°-90° relative to a linear axis of movement of the second mold part. The wall portion, or the casting cavity portion delimited by the latter, thus forms an almost horizontally extending part of the casting, i.e., for example, a basin base or a bowl base on which the opening is formed.

According to a refinement of the invention, it can be provided that the second fastening interface, when closing the casting mold, by bearing on the first mold half is able to slide to a terminal position in the first fastening interface. This design embodiment of the invention allows the insert part to be fixed manually to the first fastening interface in such a way that it is held on the latter but is not yet pushed all the way to the terminal position, i.e. pushed to the end of the groove formed on the rear mold face and finally clamped there. This final movement to the terminal position or clamping position or, if provided, the latching position is effected by interaction of the insert part with the first mold half or the front mold face, against which the insert part moves, wherein the insert part is pushed to the terminal position as a result of contact.

In a concrete embodiment of the invention, the first fastening interface can be embodied as a depression in the rear mold face, and the second fastening interface can be embodied as an elevation on the insert part. Thus, provided on the rear mold face is, for example, a groove which is undercut on both sides and optionally narrows down, said groove being part of a dovetail connection and forming the depression, while formed on the insert part is a shape-compatible elongate protrusion, likewise having a dovetail cross section, as the elevation. The design of the first fastening interface provided on the rear mold face as a depression is particularly advantageous in that the casting mold can also be used without the insert part. For example, an overflow opening is only mandatory in some countries or regions, but not in other countries or regions. The casting mold according to the invention can also be used for the production of castings or sink bodies or sinks without an overflow opening. This is because if the casting cavity is filled with a casting compound in the absence of an inserted insert part, the depression is also filled with the casting compound or polymer. A corresponding elevation is formed on the invisible rear side of the finished casting, which is discreet. Forming the depression in the rear mold face, which is formed, for example, by means of a nickel bowl, which has a thickness of usually 2.5 - 5 mm, is possible by appropriate shaping or corresponding material subtraction, the depth of the depression preferably being approx. 2 mm, but can also be slightly larger if the nickel bowl is of the appropriate thickness.

The insert part per se is preferably a hollow body which has a base on which the projecting second fastening interface is provided. The hollow body has a certain elasticity, so that compression of the front mold face, thus of the nickel bowl thereon, arises in particular when closing the mold, i.e. when the first mold part moves against the insert part, because the insert part, being a hollow body, open toward the front mold face, for example, is sufficiently flexible or elastic. Of course, an embodiment as a solid material component is also conceivable, particularly when the insert part is made of a sufficiently elastic or soft material. Preferably, the insert part is manufactured as a plastics material component.

The hollow body can be quasi closed when the insert part is embodied as a hollow body. However, it can also be pot-like, and only have a base and an encircling lateral wall, so that the insert part is open on one side. The wall can be supported by a plurality of internally extending support webs. A thin wall is expedient for providing the desired elasticity and deformation capability, as described above.

As explained, in the assembled position, the insert part bears on the rear mold face, to which it is fastened, as well as on the front mold face. Preferably, it bears on the respective face by way of a sealing contact, i.e. providing a liquid-tight transition from the respective mold face, or nickel bowl, to the insert part. It is prevented by this sealing contact that the casting compound, or a casting compound component, which is very liquid, as usual in the case of an acrylic-based polymer compound, can flow between the insert part and the mold face. In addition, there is a minimal deficit of material in the adjacent mold face regions, this compromising the visual appeal in particular on the front side of the completed casting, in most cases due to dulling or color variation, which is of course undesirable. However, if sealing contact is provided, in particular in relation to the front mold face, but preferably of course also in relation to the rear mold face, no inflow occurs in any region.

In order to implement the sealing contact, a peripherally encircling sealing element is provided on the insert part, preferably on both sides. Such a sealing element can be embodied, for example, as a sealing lip. Both sealing elements can be embodied as sealing lips, wherein in particular the sealing element which is adjacent to the front mold face is embodied as a flexible lip, which is slightly deformed when closing the mold and forms a slight chamfer, which facilitates the demolding of the insert part from the finished casting and generates a deburred edge.

The insert part per se is preferably made of plastics material. For example, polypropylene can be used, or any other suitable plastic having sufficient softness or elasticity to ensure that damage to any of the mold faces is prevented when closing the mold.

In a refinement of the invention, at least the second mold half can have a heating device by way of which the rear mold face is able to be heated. As the rear mold face is heated, the insert part is also heated at least in the region in which the two fastening interfaces are connected to one another. If the insert part is made of plastics material as described, heating causes a slight volumetric increase, i.e., the insert part also expands in the region of the second fastening interface, which causes an improvement in the clamping effect or latching action with the first fastening interface.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows a schematic illustration of a casting mold according to the invention,

FIG. 2 shows a perspective partial view of the casting mold from FIG. 1 in an exploded view, illustrating two mold parts in the form of metal layers which form the front side and the rear side of the casting, and of an insert part,

FIG. 3 shows a top view of the assembled metal layers in the closed position,

FIG. 4 shows a sectional view along the line IV-IV in FIG. 3 through the two metal layers in the casting position, with an insert part disposed therebetween,

FIG. 5 shows an enlarged detailed view of the region V in FIG. 4,

FIG. 6 shows a partial view of the second metal layer with a view of the rear mold face and the insert part fastened thereto,

FIG. 7 shows a sectional view along the line VII-VII in FIG. 6,

FIG. 8 shows a sectional partial view of a completed casting with an insert part still located therein, and

FIG. 9 shows the casting from FIG. 8 after removing the insert part.

### DETAILED DESCRIPTION OF THE INVENTION

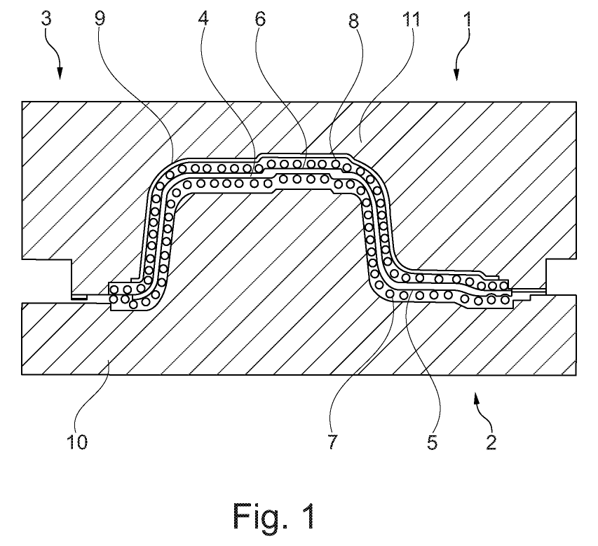

FIG. 1 shows a schematic illustration of a casting mold 1 according to the invention, which is used to produce a casting, having a front side and a rear side, in the form of a kitchen sink consisting of a composite material. The casting mold comprises a first mold part 2 which is used to shape or define the front side of the casting to be produced, and a second mold part 3 which is used to shape or define the rear side of the casting to be produced. Both mold parts bear peripherally on one another and delimit a casting cavity 4 incorporated into which is a casting compound consisting of a curable polymer compound, that is to say a reaction compound, into which particulate fillers such as quartz sand and the like are included. While the first mold part 2 is typically in a fixed position, the second mold part 3 can be moved vertically, that is to say can be placed onto the lower first mold part 2 for the purpose of closing the casting cavity 4.

The casting cavity 4 per se is delimited by a first metal layer 5 which is disposed on the first mold part 2, and a second metal layer 6 which is disposed on the second mold part 3. The casting compound incorporated comes into contact with these two metal layers 5, 6, thus bears on the area of these two metal layers 5, 6. A first heating device 7, which occupies almost the entire area of the rear side of the first metal layer 5, is disposed on the rear side of the first metal layer 5. This heating device 7 can be used to control the temperature of the first metal layer 5, and said first metal layer can be used to heat the casting compound from the front side. The second mold part 3 also has a second heating device 8 which is disposed on the rear side of the second metal layer 6, so as to ultimately cover the full area of the latter. The second heating device 8 can be used to control the temperature of the second metal layer 6, and said second metal layer can be used to control the temperature of the casting compound, consequently it is thus possible to control the heat input into the casting compound from the rear side. The second heating device 8 is optionally followed by an elastic and compressible intermediate layer 9, preferably composed of a foam rubber, said intermediate layer thus constituting a restoring means or restoring element which makes a certain degree of mobility of the second metal layer 6 possible and which at the same time ensures that the second metal layer 6 can be returned back into a defined starting position so as to compensate for any potential shrinkage of the polymer casting compound. The two metal layers 5, 6 are preferably nickel layers or nickel bowls, wherein the metal layer 5 can be described as a visible side bowl, because it forms the visible surface of the casting or the kitchen sink, and the metal layer 6 as a rear bowl, because it forms the rear of the casting or the kitchen sink. The intermediate layer 9 as embodied is not mandatory. In such a case, the shrinkage compensation can be performed by a mutual relative movement of the two mold parts 2, 3.

Furthermore, the first mold part 2 has a first mold part carrier 10, the first heating device 7 in turn bearing thereon. The second mold part 3 also has a second mold part carrier 11, the elastic, compressible intermediate layer 9 bearing thereon. Both mold part carriers 10, 11 are preferably made at least in portions of polymer concrete, in as far as the metal layers are supported thereon.

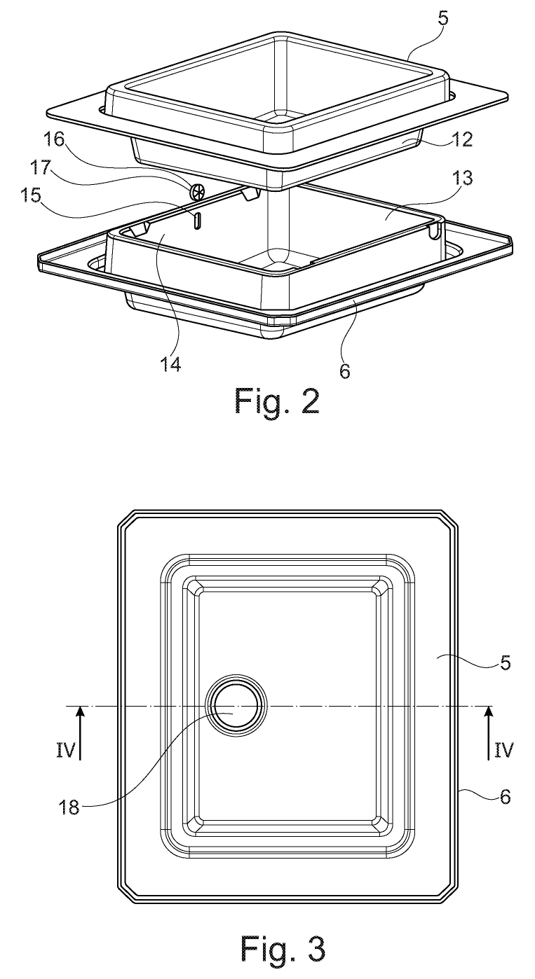

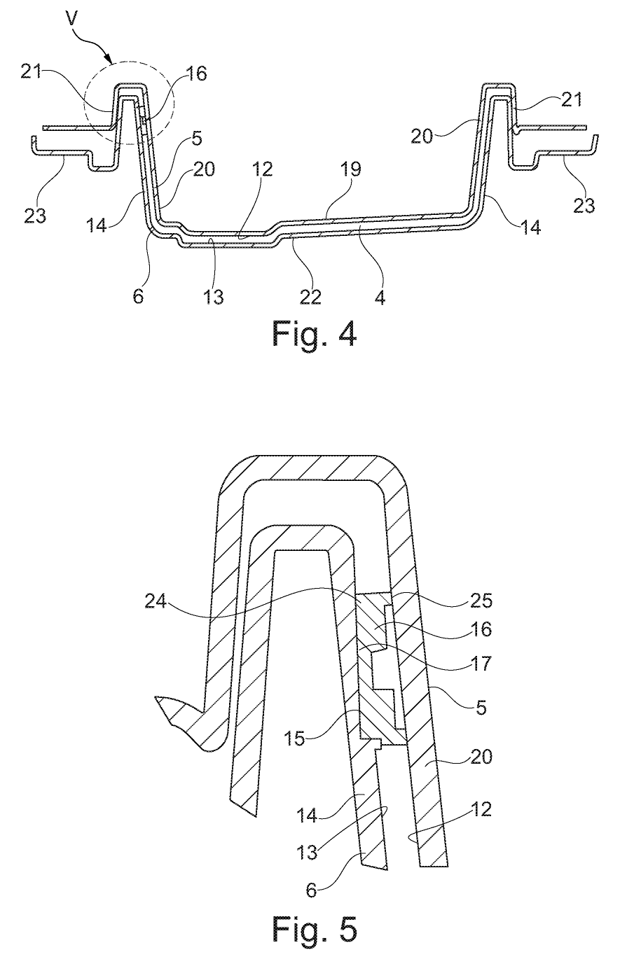

FIG. 2 shows in an exploded view the first metal layer 5 and the second metal layer 6, wherein the first metal layer 5 is a mold component of the first mold half 2 and the metal layer 6 is a mold component of the second mold half 3. Compared with FIG. 1, for reasons of clarity the two metal layers 5, 6 are shown here in a reversed arrangement, proceeding from FIG. 1, the first metal layer 5 would be below, and the second metal layer 6 above (this also applies to the illustrations in FIGS. 4 and 5). The first metal layer 5 is used to form a front of the completed casting, which is why the first metal layer 5 has a front mold face 12. The second metal layer 6 is used to form the rear of the casting, therefore the second metal layer 6 has a rear mold face 13. Since the casting mold 1 shown serves to produce a kitchen sink which has a basin portion, the first metal layer 5 engages in the second metal layer 6 when joining the two mold haves 2, 3 and thus the metal layers 5, 6, so that the casting cavity 4 which is shown in FIG. 1 and obviously has the shape of a basin is formed.

The formed basin has a quasi-rectangular shape, with a base and four encircling lateral walls. Accordingly, the two metal layers 5, 6 also have a corresponding base portion and corresponding wall portions. A first fastening interface 15, which is embodied in the form of an elongate groove that is undercut on both sides and is used to form a dovetail connection, is formed on the inside, thus the rear mold face 13, on a wall portion 14 of the second metal layer 6. It is used for fastening an insert part 16, which has a second fastening interface 17 on its rear side, which is embodied as an elongate protrusion compatible with the shape of the groove geometry, so that this second fastening interface 17 is able to slide into the first interface 15 by way of a linear sliding movement, thus establishing a form-fitting dovetail connection. In the final inserted terminal position, a slight clamping connection is provided, so that the insert part 16 is firmly secured accordingly before closing the mold. An opening in the completed cured casting is defined via the insert part 16, which opening is still closed via the insert part 16, but can be opened by simply pushing out the insert part 16. This opening forms an overflow opening of the completed casting and is located on an almost vertical wall (the wall can be at a small demolding angle of 4°-6° relative to the vertical) of the casting, which is defined via two adjacent wall portions of the rear mold face 13 and the front mold face 12.

FIG. 3 shows the two metal layers 5, 6 in their joining position, i.e. that the two metal layers engage in one another and are positioned relative to one another and established so that the casting cavity 4 shown in FIG. 1 is formed. FIG. 3 shows a top view of the assembly, meaning that the first metal layer 5 can be seen from above, which engages in the second metal layer 6 which is not visible in more detail and of which only the encircling periphery is shown. A mold portion 18 is shown, which is used to form in the completed casting a drain opening in the base of the casting.

FIG. 4 shows a sectional view along line IV-IV in FIG. 3. It shows the two metal layers 5, 6 in the position they assume relative to one another when the two mold halves 2, 3 are closed. The casting cavity 4 is visible, which is delimited on all sides by the mutually spaced apart metal layers 5, 6. The metal layer 5 for delimitation has a base portion 19 and wall portions 20 which extend at an angle of little more than 90° relative to the base 19 and which are adjoined by laterally protruding mold portions 21. The lower metal layer 6, forming the rear, also has a base portion 22 and wall portions 14 which extend at an angle of little more than 90° relative thereto and which are likewise adjoined by corresponding mold portions 23 that extend laterally. As can be seen, the base portions 19, 22 and the wall portions 20, 14 for forming the casting cavity 4 are slightly spaced apart from one another. The metal layer 5 has on the side facing the metal layer 6 the front mold face 12, while the metal layer 6 has on the side facing the metal layer 5 the rear mold face 13.

Disposed between two adjacent wall portions 14, 20 is the insert part 16 which is disposed on the wall portion 14 and on the rear mold face 13 of the latter, and is connected in sealing contact to the rear mold face 13 of the wall portion 14. On the other side, sealing contact is provided on the front mold face 12 or the adjacent wall portion 20. The arrangement is shown in an enlarged view according to FIG. 5.

FIG. 5 shows in an enlarged view the region V from FIG. 4. The wall portion 14 of the metal layer 6 and the adjacent wall portion 20 of the metal layer 5 are in fragments. The corresponding front mold face 12 is adjacent to the rear mold face 13. Formed on the rear mold face 13 of the wall portion 14 is the first fastening interface 15 in the form of the elongate groove already described, while formed on the rear of the insert part 16 is the second fastening interface 17 in the form of the elongate, shape-compatible protrusion that engages in the groove. As already indicated in FIG. 2, the second fastening interface 17 in the form of the protrusion is introduced into the first interface 15 by a linear, almost vertical insertion movement, or one that is at a small angle, said second fastening interface preferably being received therein in a slight clamping manner in such a way that a clamping connection is established. The insert part 17 bears in sealing contact on the rear mold face 13, for which purpose an encircling sealing element 24 is disposed on the rear side of the insert part 17 that points toward the rear mold face 13. The insert part 17 per se is made of plastics material, so that the sealing element 24 is also made of plastics material, for example from a slightly softer plastics material than the rest of the body of the insert part 16, which can be implemented in a 2-component injection-molding process. On the other side, the insert part 16 has a further encircling sealing element 25, here in the form of a projecting sealing lip, which bears on the front mold face 12 and is potentially slightly deformed by the latter. This sealing element 25 can also be made of a slightly softer plastics material than the remaining body of the insert part 16 and be integrally molded thereon in a 2-component injection-molding process. If the insert part 16 is made altogether of a sufficiently elastic or flexible and soft plastics material, for example polypropylene, the sealing elements 24, 25 can be formed directly from this plastics material. The sealing element 24 may be a simple encircling annular protrusion, which must not necessarily be embodied as a sealing lip, while the second sealing element is preferably a projecting encircling sealing lip.

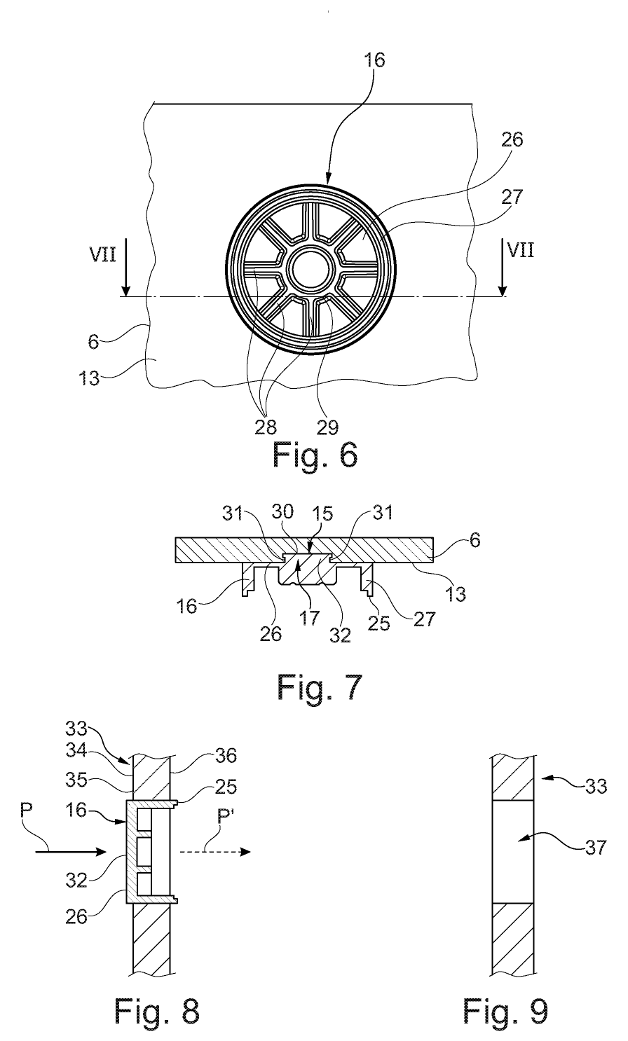

FIG. 6 shows a top view of the rear mold face 13 of the second metal layer 6 and the insert part 16 fastened thereto. The latter is designed as a hollow body which has a base 26, the sealing element 24 being integrally molded on its rear side, as discussed. The insert part 16 is embodied as a circular component, so that a circular encircling wall 27 extends from the base 26. A corresponding reinforcement is provided via various webs 28 and a central annular web 29. The insert part 16 is open toward the opposite front mold face 12.

FIG. 7 shows a sectional view along the line VII-VII from FIG. 6. The metal layer 6 is shown with its rear mold face 13 on which is formed the first fastening interface 15. The latter is embodied in the form of a groove 30, which, as shown in FIG. 2, extends quasi vertically or at a small angle along the wall portion 14 and is embodied on both sides in the undercuts 31 in the manner of a dovetail. The width of the groove 30 can slightly narrow down over its length, so that a type of wedge shape is formed.

Furthermore shown is the insert part 16, and formed on the rear side of the base 26 thereof is the second fastening interface 17 in the form of an elongate protrusion 32 protruding on both sides. The cross section is shape-compatible with the cross section of the groove 30, and the width of the protrusion 32 likewise narrows down over its length, following the shape of the groove 30. For assembling, the protrusion 32, proceeding from FIG. 2, is pushed from above into the groove 30, for example home to the terminal position, in which said protrusion is pushed into the groove 30 to the maximum and is clamped in the latter. The clamping action is ensured by the narrowing geometries. Alternatively, it is conceivable that only portions of the insert part 16 or the protrusion 32 are pushed into the groove 30 until a slight clamping effect is provided, but the protrusion 32 is not in the final maximum terminal position. When the mold is closed, the second mold part 3 or the second metal layer 6 is thus moved against the first metal layer 5, the front mold face 12 thus coming to bear on the insert part 16 or the sealing element 25. As a result of this contact, the insert part 16 is moved linearly somewhat further and pushed into the final terminal position in the groove 30, wherein sealing contact of the insert part 16 in relation to the front mold face 12 by way of the sealing element 25 as well as in relation to the rear mold face 13 by way of the sealing element 24 is simultaneously achieved.

After closing the mold, the casting cavity 4 is also closed, except for a material access by way of which the casting compound is incorporated into the casting cavity 4. The casting compound is distributed completely in the casting cavity 4, in the process flowing about the insert part 16, the latter being in sealing contact in relation to the rear mold face 13 as well as in relation to the front mold face 12, as discussed. This sealing contact prevents the liquid portion of the casting compound from making its way between the insert part 16 and one of the mold faces 12, 13. It is therefore completely embedded in the casting compound. Then the casting compound cures, which is thermally initiated in a heat-curing casting compound by heating the two metal layers 5, 6 by way of the corresponding heating devices 7, 8. As a result of this heating, in addition to the metal layer 6, at least the protrusion 32 of the insert part 16 is also somewhat heated. Since the latter is made of plastics material, it expands slightly, the clamping connection being even furthermore improved thereby. Alternatively, curing can also take place without heating by adding special peroxides, i.e. by using a cold-curing casting compound.

The casting mold 1 is opened once the casting compound has cured, thus the casting has been formed. In the process, the two mold halves 2, 3 are diverged, whereby presently the upper second mold half 3 is moved vertically upward. The casting can now be retrieved from the lower mold half 2. Since the insert part 16 is firmly embedded in the casting, it is inevitably entrained during removal, wherein the two fastening interfaces 15, 17 are released from one another, i.e. that the protrusion 32 is pulled out of the groove 30 again in the direction counter to its insertion direction. In order to form the final opening on the casting per se, it is only necessary to push the insert part 16 out of the casting, or the finished wall. This is particularly easy if the polymeric casting compound does not adhere excessively to the insert part, so that it is possible to push the latter out with little effort in terms of force.

This is shown in FIGS. 8 and 9. FIG. 8 shows the removed casting 33, wherein the embedded insert part 16 is received in a basin wall 34 and has been removed conjointly with the casting 33. The casting 33 has a rear side 35 and a front side 36. The protrusion 32 protrudes slightly on the rear side 35, while the sealing element 25, thus the sealing lip, slightly projects from the front side. In order to form the opening, it is now necessary to press toward the base 26 of the insert part 16 with a small effort in terms of force, see arrow P, for example, so that the insert part 16 is pushed out laterally, as is indicated by the dashed arrow P´. Of course, pushing out can also be performed in the opposite direction, toward the rear side.

The completed casting 33 with the formed opening 37 is then shown in FIG. 9, wherein the opening 37 is an overflow opening and the casting 33 is a kitchen sink and the basin wall 34 laterally delimits the sink.

Forming the fastening interface 15 as a groove 30 on the rear mold face 13 is also advantageous in that the casting mold 1 according to the invention can also be used without an insert part 16. In some cases, forming such an overflow opening on a sink body is not necessary. The use of an insert part 16 is not mandatory in this instance, but the casting mold 1 can nevertheless be used. In this case, the casting compound also flows into the groove 30, so that a corresponding protrusion that follows the groove geometry is formed on the rear side of the completed casting. When demolding the casting from the lower mold half or the metal layer 6 by vertical lifting, this protrusion formed on the casting is inevitably pushed linearly out of the groove 30. Since said protrusion is on the rear side, it is discreet.

While FIG. 6 shows an insert part 16 in a circular form, which causes a round overflow hole to be formed, the shape of the insert part 16 can of course be arbitrary. It can be oval, polygonal, star-shaped, heart-shaped, elongate/slot-like and similar, ultimately the concrete geometry is almost unlimited because the shape of the opening is defined by the peripheral geometry of the wall 27 of the insert part 16.

Of course, it is conceivable to form not only one opening, depending on the casting to be produced, but for example two or more, e.g. in the case of a correspondingly large sink or washbasin, etc. In this case, a corresponding plurality of fastening interfaces 15 would have to be provided on the rear mold face 13, permitting the disposal of a corresponding plurality of insert parts 16, the latter being identical or dissimilar in terms of geometry. However, the geometry of the respective fastening interfaces 15, 17 is always the same.

Instead of the kitchen sink described by way of example, a different body can of course be produced as a casting, such as a shower bowl or shower tray, a washbasin or the like.

While specific embodiments of the invention have been shown and described in detail to illustrate the inventive principles, it will be understood that the invention may be embodied otherwise without departing from such principles.

We claim:

1. A casting mold for producing a casting having a front and a rear side from a curable casting compound, having at least one first mold part with a front mold face that shapes the front side and a second mold part with a rear mold face that shapes the rear side, which mold parts conjointly delimit a casting cavity, wherein provided on the rear mold face is a first fastening interface and provided on an insert part, by way of which a through hole on the casting is to be formed, is a second fastening interface, wherein the insert part in the case of a closed mold bears on the rear mold face as well as on the front mold face, and wherein the two fastening interfaces are releasably connectable to one another in such a manner that, when removing the second mold part from the cured casting, the first fastening interface is automatically released from the second fastening interface.

2. The casting mold according to claim 1, wherein the second fastening interface is insertable into the first fastening interface by way of a linear sliding movement and, when removing the second mold part, the second fastening interface is extractable from the first fastening interface by way of a linear movement.

3. The casting mold according to claim 2, wherein the first fastening interface and the second fastening interface establish a clamping connection.

4. The casting mold according to claim 3, wherein the first fastening interface and the second fastening interface establish a dovetail connection.

5. The casting mold according to claim 2, wherein the first fastening interface is disposed on a wall portion of the rear mold face that is at an angle of 0.1° - 7° relative to a linear axis of movement of the second mold part.

6. The casting mold according to claim 2, wherein the first fastening interface and the second fastening interface establish a latching connection.

7. The casting mold according to claim 6, wherein the first fastening interface is disposed on a wall portion of the rear mold face that is at an angle of 85° - 90° relative to a linear axis of movement of the second mold part.

8. The casting mold according to claim 2, wherein the second fastening interface, when closing the casting mold, by bearing on the front mold face is able to slide to a terminal position in the first fastening interface.

9. The casting mold according to claim 1, wherein the insert part is disposed on a mandrel or in a depression which is provided on a substantially horizontal portion of the rear mold face.

10. The casting mold according to claim 1, wherein the first fastening interface is embodied as a depression in the rear mold face and the second fastening interface is embodied as an elevation on the insert part.

11. The casting mold according to claim 10, wherein the insert part is a hollow body and has a base on which the projecting second fastening interface is provided.

12. The casting mold according to claim 11, wherein the insert part, which is open on one side, has an encircling lateral wall which is supported by a plurality of internally extending support webs.

13. The casting mold according to claim 1, wherein the insert part when in sealing contact bears on the rear mold face as well as on the front mold face.

14. The casting mold according to claim 13, wherein provided on both sides of the insert part is in each case one peripherally encircling sealing element.

15. The casting mold according to claim 14, wherein a sealing element is designed as a sealing lip.

16. The casting mold according to claim 1, wherein the insert part is made of plastics material.

17. The casting mold according to claim 1, wherein at least the second mold half has a heating device by way of which the rear mold face is able to be heated.
